(19) United States
(12) Patent Application Publication
(10) Pub. No.: US 2019/0291387 A1
(43) Pub. Date: Sep. 26, 2019

(54) INSULATING GLAZING UNIT HAVING A PYROTECHNIC MODULE

(71) Applicant: SAINT-GOBAIN GLASS FRANCE, Courbevoie (FR)

(72) Inventors: Marcus NEANDER, ESCHWEILER (DE); Manfred GILLISSEN, HERZOGENRATH (DE)

(21) Appl. No.: 16/302,613

(22) PCT Filed: Jul. 26, 2017
(86) PCT No.: PCT/EP2017/068894

§ 371 Date: Nov. 16, 2018

(30) Foreign Application Priority Data
Aug. 9, 2016 (EP) 16183336.3

(51) Int. Cl. B32B 17/10; F41H 5/007; F41H 5/04; F41H 9/08

(52) U.S. Cl. CPC B32B 17/10055; F41H 5/007; E06B 3/66; F41H 9/08; F41H 5/0407

(57) ABSTRACT

An insulating glazing unit including a first pane and a second pane bonded to a circumferential spacer is presented. The first/second panes are respectively bonded to a first/second pane contact surfaces of the spacer. The first pane, the second pane, and a glazing interior surface of the spacer enclose an inner interpane space of the insulating glazing unit. According to one aspect, the insulating glazing unit includes a pyrotechnic module that contains a pyrotechnic composition and an igniter. The pyrotechnic composition releases an aerosol in the inner interpane space after activation by the igniter. Methods for production and use of the insulating glazing unit are also presented.

The invention relates to an insulating glazing unit, in particular a bullet-resistant insulating glazing unit, having a pyrotechnic module, a method for production thereof, and use thereof.

The thermal conductivity of glass is lower by roughly a factor of 2 to 3 than that of concrete or similar building materials. However, since, in most cases, panes are designed significantly thinner than comparable elements made of brick or concrete, buildings frequently lose the greatest share of heat via external glazing. The increased costs necessary for heating and air-conditioning systems make up a part of the maintenance costs of the building that must not be underestimated. Moreover, as a consequence of more stringent construction regulations, lower carbon dioxide emissions are required. Insulating glazing units, without which, primarily as a result of increasingly rapidly rising prices of raw materials and more stringent environmental protection constraints, it is no longer possible to imagine the building construction sector, are an important approach to a solution for this.

In addition to the insulating action of glazings, the protective action of glazings also plays a critical role depending on the field of application. Standard DIN/EN 1063 regulates the testing of bullet-resistant glazings. It describes methods for testing bullet resistance using standardized methods. The testing for bullet resistance is done using standardized pane sizes of 500 mm×500 mm, with three shots each per pane submitted, whose points of impact form a triangle with side lengths of 120 mm in the center of the pane. Depending on the type of projectile used and the firing distance, the glazings are assigned to the bullet-resistance classes BR1 to BR7 as well as SG1 and SG2.

Composite glasses with bullet resistance are well known to the person skilled in the art. They are usually laminates of a plurality of panes that are bonded to one another via a laminating film. In order to achieve the desired bullet resistance, the number of panes, the thickness of the panes as well as the thickness of the laminating film must be selected appropriately. Moreover, polymeric panes can be used for improving bullet resistance. Thus, for example, U.S. Pat. No. 4,243,719 A, DE 3486336 T2, DE 102008043718 A1, and DE 102012220009 A1 disclose safety glazings with plastic-glass laminates of glass and polycarbonate or polymethyl methacrylate.

The insulating action of composite glass panes is low compared to relevant insulating glazing units. Consequently, such safety glazings are also implemented as insulating glazing units. Among others, EP 2363285 A1 and DE 202008005366 U1 describe insulating glazing units including glass laminates or glass-plastic laminates. On the one hand, these satisfy increased safety requirements, and, on the other, they have reduced thermal conductivity due to their insulating action.

In addition to penetration-resistant and bullet-resistant glazings themselves, technical means for monitoring the integrity of these panes are also available. For example, insulating glazing units can be implemented as alarm panes, wherein one pane is made of single-pane safety glass and has a printed-on electric conductor loop. In the event of destruction of the single-pane safety glass, the flow of current through the conductor loop is interrupted, as a result of which the damage to the insulating glazing unit can be detected. Such glass breakage detectors can be obtained in a wide variety of implementations. In addition to the mode of operation mentioned, these can also be based on detection of moisture in the broken interpane space, the detection of sound or vibrations, the detection of changes in position of the pane, as well as combinations of the principles mentioned. Examples of such glass breakage detectors are found in DE 102006046859 A1 and WO 2015154688.

As already discussed, the classification of a glazing into the corresponding bullet-resistance class is done using standardized tests per DIN/EN 1063. The shot patterns generated in this manner do not necessarily correspond to the bullet holes occurring in a threat situation. Moreover, in practice, an attacker can, of course, choose a larger caliber weapon for which the protection class of the glazing is not designed. Thus, it is basic that individuals under fire have the capability of already moving out of the threat zone after the first shot. It should be mentioned that suitable bullet-resistant glazings do, indeed, trap the projectile and thus ensure the physical safety of the potential victims but also retain their transparency even after a first bullet hole. Vision through the glazing is, to be sure, inhibited in the immediate vicinity of the bullet hole; however, transparency is extensively maintained such that a shooter can aim unhindered through the pane.

RU 127890 U1 discloses a bullet-resistant insulating glazing unit comprising a composite pane with a glass breakage detector on the attack side of the glazing and a composite pane with electrochromic glazing on the protected side of the glazing. Damage to the composite pane situated on the attack side is detected by means of the glass breakage detector via a control unit that switches the electrochromic glazing into an opaque state via a corresponding signal. Thus, the bullet-resistant glazing is shifted into a nontransparent state after impact of the first projectile such that the shooter no longer has the capability of training his sight on the individuals on the protected side of the glazing for another shot. Such a solution is comparatively complex and thus also cost intensive to produce. Moreover, reliable operation of the switchable glazing cannot be guaranteed under fire. The projectile could possibly, depending on caliber and on the protective class of the bullet-resistant glazing, not remain in the attack-side composite pane of the glazing but could, instead, penetrate into the protected-side composite pane and only be stopped there. This is accompanied by damage to the switchable glazing that can result in loss of function. The protected-side composite pane with switchable glazing can also be damaged by splintering of the attack-side composite pane. It is also known that just the shockwave of the impacting projectile can result in damage to protected-side panes even if these forward positioned panes of the respective composite pane remain undamaged. This yields a non-negligible risk of failure of the switchable glazing with simultaneously high production outlays.

An object of the present invention is to provide an improved insulating glazing unit that overcomes the described disadvantages of the prior art, a method for producing this insulating glazing unit according to the invention, and use thereof.

The object of the present invention is accomplished according to the invention by an insulating glazing unit in accordance with the independent claim 1. Preferred embodiments of the invention are apparent from the subclaims.

The insulating glazing unit comprises at least a first pane, a second pane, and a circumferential spacer arranged between the first and the second pane. The spacer for the insulating glazing unit according to the invention comprises at least a first pane contact surface and a second pane contact surface running parallel thereto, a glazing interior surface, and an outer surface. The first pane is attached to the first pane contact surface of the spacer, whereas the second pane is attached to the second pane contact surface. Thus, the first pane, the second pane, and the glazing interior surface enclose an inner interpane space. The insulating glazing unit according to the invention further includes a pyrotechnic module that contains a pyrotechnic composition and an igniter. The pyrotechnic composition is ignited by activation by means of the igniter and releases an aerosol in the inner interpane space.

The aerosol released in the inner interpane space obstructs visibility through the glazing such that an attacker can no longer discern a target individual situated on the opposite side of the glazing and another targeted shot at the target individual is rendered difficult. The solution according to the invention further has high fault tolerance since the release of the aerosol occurs even independently of the damage state of the panes of the glazing. With a very highly damaged pane arrangement, switchable glazings known, for example, from the prior art would no longer ensure fault-free operation. In contrast, the production of the aerosol according to the invention is still possible even if the first pane and the second pane have extensive damage.

The first pane contact surface and the second pane contact surface are the sides of the spacer on which, during installation the spacer, the assembly of the outer panes (first pane and second pane) of an insulating glazing unit is done. The first pane contact surface and the second pane contact surface run parallel to each other.

The glazing interior surface is defined as the surface of the main body of the spacer that face in the direction of the interior of the glazing after installation of the spacer in an insulating glazing unit. The glazing interior surface is positioned between the first and the second pane.

The outer surface of the main body of the spacer is the side opposite the glazing interior surface, which outer surface faces away from the interior of the insulating glazing unit in the direction of an outer seal.

The outer surface of the spacer can, in a possible embodiment, be angled in each case adjacent the pane contact surfaces, by which means increased stability of the polymeric main body is achieved. The outer surface can, for example, be angled in each case adjacent the pane contact surfaces by 30 to 60° relative to the outer surface.

The outer interpane space is defined as the space delimited by the first pane, the second pane, and the outer surface of the spacer.

The insulating glazing unit according to the invention has one glazing outer surface defined as the attack side and one defined as the protected side. The outer surface of the first pane is oriented in the direction of the attack side, whereas the outer surface of the second pane is the protected side.

The attack side of the glazing is referred to as the outer pane side starting from which an attack on the glazing must be reckoned with. In the case of a glazing for bullet resistance, this is the pane oriented toward the building or room exterior. The protected side refers to the opposite glazing side on which the item to be protected or the individuals to be protected are situated. In the case of said use of the glazing for protection against gunfire, this would be the glazing side oriented toward the building or room interior.

It is also conceivable to outfit a glazing with two attack sides if gunfire from both sides must be reckoned with. In this case, the first and the second pane are implemented such that an appropriate protective effect is equally present from both sides. Corresponding structures are known to the person skilled in the art from the prior art.

Of course, the insulating glazing unit according to the invention can also be implemented as a conventional insulating glazing unit, without special protection.

The wide variety of spacers known to the person skilled in the art can be used as the spacer of the insulating glazing unit according to the invention since the solution according to the invention is compatible with any spacers.

In a possible embodiment, the insulating glazing unit according to the invention has a spacer with a polymeric or a metallic main body including at least one hollow chamber. A suitable spacer with a polymeric main body is disclosed, for example, in WO 2013/104507 A1.

Hollow profile spacers known to the person skilled in the art include at least one hollow chamber in a usually polymeric or metallic main body. The hollow chamber is adjacent the glazing interior surface, with the glazing interior surface situated above the hollow chamber, and the outer surface of the spacer is situated below the hollow chamber. “Above” is defined in this connection as facing the inner interpane space of the insulating glazing unit, and “below” is defined as facing away from the interpane space.

The hollow chamber of the spacer of the insulating glazing unit according to the invention results in a weight reduction in comparison to a solidly molded spacer and is available for accommodating additional components, for instance, a desiccant.

In another possible embodiment, the insulating glazing unit according to the invention includes an injection moldable thermoplastic spacer made of a sealing material. Such spacers are, for example, known from DE 696 07 473 and WO 2015/197491 A1.

In both said embodiments of the spacer, the desiccant preferably contains silica gels, molecular sieves, CaCl₂, Na₂SO₄, activated carbon, silicates, bentonites, zeolites, and/or mixtures thereof. This is advantageous since, thus, the residual moisture present in the inner interpane space can be bound. The desiccant is preferably incorporated into the main body of the spacer. In the case of injection moldable thermoplastic spacers, the desiccant is usually integrated into the injection moldable sealing material. In the case of hollow body spacers, the desiccant is preferably situated in the hollow chamber of the main body.

In a preferred embodiment of the hollow body spacer, the glazing interior surface has at least one opening. Preferably, a plurality of openings are made in the glazing interior surface. The total number of openings depends on the size of the insulating glazing unit. The openings connect the hollow chamber to the inner interpane space, as a result of which a gas exchange is possible therebetween. This enables absorption of atmospheric moisture by the desiccant situated in the hollow chamber and, thus, fogging of the panes is prevented. The openings are preferably implemented as slits, particularly preferably as slits with a width of 0.2 mm and a length of 2 mm. The slits ensure optimum air exchange without the desiccant being able to penetrate out of the hollow chamber into the interpane space.

A wide variety of mechanisms are conceivable for activating the igniter of the pyrotechnic module, for example, manual triggering via an electrical switch by the individual situated on the protected side of the glazing or a security service that has detected intrusion of an unauthorized individual into a zone to be protected. The automated triggering of the igniter is preferred since, in this manner, protection is also ensured without the individuals to be protected having noticed the possible attack or the surrounding terrain being monitored.

Automated triggering of the igniter of the pyrotechnic module can be done, for example, by direct or indirect monitoring of the condition of the first and/or second pane. In this case, preferably, at least the breakage of the first pane situated on the attack side of the glazing unit is monitored. Optionally, the integrity of the second pane can also be appropriately detected, for example, if an attack from both sides of the glazing is to be reckoned with. The igniter can be activated either by mechanical ignition, for example, by a friction igniter, or by electrical ignition.

In a preferred embodiment, the igniter of the pyrotechnic module is electrically conductingly connected to a glass breakage detector that can trigger an ignition of the igniter. A wide variety of suitable glass breakage detectors, for example, moisture detectors for detection of incoming atmospheric moisture in the interpane space, sound detectors, vibration detectors, or electric conductor loops in contact with the pane to be monitored, are known to the person skilled in the art.

The contact between a glass breakage detector and a pyrotechnic module can be made via a variety of transmission paths, for example, by direct contact of the two components with an electrical conductor but also via wireless transmission, for example, by using radio, WLAN, Bluetooth, or infrared transmitter and receiver pairs. In this case, the glass breakage detector has a transmission unit, preferably a radio transmission unit with a radio signal whose frequency is in the range from 100 kHz to 100 GHz. The radio transmission unit is particularly preferably a Bluetooth transmitter or a WLAN transmitter. Alternatively, the second transmission unit can also be an infrared transmitter. The second transmission unit serves for communication with a receiver for emitting an alarm signal when the detector detects breakage of the pane. The pyrotechnic module has a receiver unit that triggers ignition of the pyrotechnic module in the event of a corresponding signal from the transmission unit. The integration of a wireless transmission unit has the particular advantage that a very simple, economical, location-independent installation within the insulating glazing unit is enabled. Of course, additional data can also be sent via the transmission unit to a receiver situated outside the insulating glazing unit, such as a functional status of the detector unit, a battery or accumulator charge status, or other parameters that are provided by other sensors, such as temperature or pressure.

In an advantageous embodiment of the pane arrangement according to the invention, the glass breakage detector has an energy supply, preferably a battery, an accumulator, a supercapacitor, a thermoelectric generator, and/or a solar cell. The detector unit comprising a glass breakage detector and an energy supply thus advantageously includes no supply lines to an external power supply, but is, instead, energy self-sufficient. Alternatively, the energy supply can also be done or supplemented by continuous or discontinuous charging via, for example, an inductive charging device. This has the particular advantage that the detector unit requires no external supply lines and, thus, a very simple, economical, location-independent installation is enabled. Furthermore, the possibility of tampering with the detector unit is eliminated, increasing safety. This is particularly advantageous for the use of the detector unit in an insulating glazing unit, which is usually sealed toward the outside.

Preferably, the first pane and/or the second pane comprise at least one pane made of single-pane safety glass, with a glass breakage detector detecting the breakage of at least one pane made of single-pane safety glass. Particularly preferably, the pane made of single-pane safety glass forms the layer of the first or second pane directly adjacent the inner and outer interpane space. This facilitates contact with the pane made of single-pane safety glass, which is possibly necessary depending on the type of glass breakage detector.

The glass breakage detector is preferably implemented as an electrically conducting loop on the surface of the at least one pane made of single-pane safety glass. Such electric conductor loops (also referred to as “alarm nets”) are particularly suitable since they enable reliable detection of pane breakage with no significant time delay and, consequently, high speed and reliability of activation.

Preferably, at least the pane of the glazing situated on the attack side includes one pane made of single-pane safety glass in combination with an electric conductor loop for detecting a glass breakage. The electric conductor loop can be applied on the pane made of single-pane safety glass both visibly in the inner interpane space, as well as invisibly in the outer interpane space for the observer.

In an alternative embodiment of the invention, the igniter is a rip igniter that is connected to a rip cord and can be ignited by means of this rip cord. Preferably, the rip cord is placed in the insulating glazing unit such that it contacts at least one subregion of an edge section of the first pane and/or the second pane to be monitored. Breakage of the corresponding pane results, via a mechanical load on the rip cord, in the activation of the rip igniter, which immediately ignites the pyrotechnic composition.

Regardless of the design of the ignition mechanism, the pyrotechnic module can be attached at various locations on the insulating glazing unit. The only requirement is that there must be a connection permeable to the aerosol between the pyrotechnic module and the inner interpane space.

In a preferred embodiment, the pyrotechnic module is installed in the inner interpane space itself. This has the advantage that the aerosol created by activating the pyrotechnic module can enter the inner interpane space completely unimpeded.

With activation of the pyrotechnic module, heat can develop in the immediate vicinity of the module. Depending on the material of the spacer used, it could be damaged by this. To avoid this, it is optionally possible either to make the spacer, completely or in sections, from a suitable heat resistant material, for example, a metal, or to apply suitable heat resistant protection, for example, a metal strip, on the glazing interior surface of the spacer in the vicinity of the pyrotechnic module.

In another preferred embodiment of the insulating glazing unit, the spacer is a hollow body spacer, which has at least one hollow chamber, in which the pyrotechnic module is attached. In this case, there is a connection permeable to the aerosol between the section of the hollow chamber that contains the pyrotechnic module and the inner interpane space. Thus, the aerosol generated by ignition of the pyrotechnic module penetrates into the inner interpane space and obstructs the view through the glazing. This embodiment is advantageous for positioning the pyrotechnic module invisible to the observer. The overall visual impression of the glazing is not disturbed by a pyrotechnic module visible in the inner interpane space.

Preferably, a plurality of openings in the glazing interior surface of the spacer are introduced in the region of the hollow chamber with a pyrotechnic module, through which openings the aerosol can enter the interpane space from the hollow chamber. The size and number of the openings in this region is a function of various factors, for example, the efficiency of aerosol generation by the pyrotechnic module used, the nature of the aerosol, and the size of the glazing interior. Provided the volume of the desired glazing interior and the pyrotechnic module used are known, the required size of the openings can be determined by the person skilled in the art through simple experiments. The openings in the region of the pyrotechnic module are usually larger than the openings in the regions outside the pyrotechnic module.

In order to improve the heat resistance of the hollow chamber spacer in the region of the pyrotechnic module, a spacer made of a metal can be used in the region of the pyrotechnic module, for example, or heat resistant protection can be used in a polymeric spacer in the region of the pyrotechnic module.

In the region of the pyrotechnic module, the hollow chamber preferably contains no desiccant in order not to inhibit the development of the aerosol. In addition, optionally, bulkheads can be introduced into the spacer adjacent the pyrotechnic module to prevent the entry of desiccant from regions without a pyrotechnic module into the region of the pyrotechnic module.

In a preferred embodiment of the invention, a hollow profile spacer is implemented as a spacer module including at least one integrated pyrotechnic module in a hollow chamber. The spacer module includes a section of a hollow profile spacer that is suitable in its length to accommodate the pyrotechnic module but does not extend substantially beyond that. The further structure of the spacer module corresponds to the structure described for the hollow profile spacer in the region of the pyrotechnic module. This spacer module can be plugged modularly into a spacer frame. Thus, it is possible to equip any spacer frame made up of hollow profiles with this spacer module and to integrate the solution according to the invention. Complicated reengineering of production is thus avoided. In addition, the spacer module can also be made from heat-resistant materials such as metal, which do, however, have a high heat transfer coefficient, whereas the rest of the spacer frame is produced, for example, from polymeric materials with low thermal conductivity and relatively low heat resistance. Thus, it is possible to achieve, simultaneously, high heat resistance in the region of the pyrotechnic module and low thermal conductivity of the entire glazing without major technical outlays.

The spacer module according to the invention can be integrated modularly into a spacer frame via connectors known to the person skilled in the art for hollow profile spacers, for example, longitudinal connectors or corner connectors.

In all embodiments mentioned, any pyrotechnic compositions known to the person skilled in the art that produce an aerosol upon ignition can be used. Suitable compositions are known, for example, from smoke tablets or smoke flares. Such compositions have long chemical shelf life. Thus, even after years of storage in the insulating glazing unit, flawless functionality is ensured.

Preferably, the pyrotechnic composition contains potassium chlorate, ammonium chloride, dihydroxyanthraquinone, black powder, barium nitrate, and/or mixtures thereof. Exemplary compositions are mixtures of potassium chlorate and ammonium chloride or mixtures of dihydroxyanthraquinone, lactose, and potassium chlorate as a smoke generator in conjunction with a mixture of black powder, barium nitrate, and potassium chlorate for the ignition charge. Particularly preferably, the pyrotechnic composition contains potassium chlorate and ammonium chloride; in particular, the pyrotechnic composition is made of potassium chlorate and ammonium chloride, with impurities possibly present.

The pyrotechnic composition can also contain, in addition to the components mentioned, further coloring components. These are also commercially available and cause the development of colored aerosols.

An aerosol is a dispersion of solid or liquid particles and a carrier gas. Liquid particles in a gaseous dispersion medium are referred to as fog, whereas solid particles in a gas are referred to as smoke. Preferably, the aerosol generated according to the invention is a smoke.

The first pane and/or the second pane of the insulating glazing unit preferably contain glass, particularly preferably quartz glass, borosilicate glass, soda lime glass, and/or mixtures thereof. The first and/or the second pane of the insulating glazing unit can also comprise thermoplastic polymeric panes. Thermoplastic polymeric panes preferably comprise polycarbonate, polymethyl methacrylate, and/or copolymers and/or mixtures thereof. These compositions are particularly suitable for increasing the bullet resistance of the insulating glazing unit. In particular, polycarbonate and polymethyl methacrylate have high bullet resistance.

The first pane and the second pane have a thickness of 2 mm to 50 mm, preferably 2 mm to 10 mm, particularly preferably 4 mm to 6 mm, with the two panes possibly even having different thicknesses.

The first and/or the second pane can also include panes made of single-pane safety glass or partially prestressed glass. Single-pane safety glass prevents, by means of its typical breakage pattern, creation of sharp shards. Partially prestressed glass has, in contrast, higher residual strength after damage to the pane.

In a preferred embodiment, the first and/or the second pane of the insulating glazing unit, in particular the first and the second pane of the insulating glazing unit are implemented as composite panes.

Preferably, the first pane and/or the second pane include at least one thermoplastic polymeric pane.

The first and/or the second pane can also be implemented as composite panes comprising a plurality of individual panes. Advantageously, these are glass-glass composites or glass-polymer composites of at least two glass panes, two polymeric panes, or one glass pane and one polymeric pane that are adhesively bonded to one another via a laminating film. This further improves the bullet resistance of the insulating glazing unit according to the invention.

The laminating films include at least one thermoplastic polymer, preferably ethylene vinyl acetate (EVA), polyvinyl butyral (PVB), or polyurethane (PU) or mixtures or copolymers or derivatives thereof. The thickness of the laminating films is preferably from 0.2 mm to 2 mm, particularly preferably from 0.3 mm to 1.5 mm. Particularly preferably, polyvinyl butyral in a thickness of, for example, 0.38 mm or 0.76 mm is used for the lamination of two glass panes. In lamination of a thermoplastic polymeric pane to another pane of the same type or to a glass pane, the person skilled in the art preferably uses polyurethane with a thickness of, for example, 1.25 mm. In the case of a composite of two glass panes, more economical laminating films, for example, made of polyvinyl butyral, can also be used.

In a particularly preferable embodiment of the insulating glazing unit, the first pane is oriented toward the attack side and is produced as a composite pane of at least one pane made of single-pane safety glass and at least one other pane. The pane made of single-pane safety glass is preferably adjacent the interpane space and an electric conductor loop is mounted as a glass breakage detector on the surface of the single pane safety glass oriented toward the interpane space.

Particularly preferably, the second pane is the protected side of the glazing and comprises a composite pane made of at least two individual panes, preferably including at least one thermoplastic polymeric pane.

The outer interpane space, delimited by the first pane, the second pane, and the outer surface of the spacer, is at least partially, preferably completely, filled with an outer seal. Thus, very good mechanical stabilization of the edge seal is achieved.

Preferably, the outer seal includes polymers or silane-modified polymers, particularly preferably organic polysulfides, silicones, room-temperature-vulcanizing (RTV) silicone rubber, peroxide-vulcanizing silicone rubber, and/or addition-vulcanizing silicone rubber, polyurethanes, and/or butyl rubber.

The sealant between the first pane contact surface and the first pane, or between the second pane contact surface and the second pane, preferably contains a polyisobutylene. The polyisobutylene can be a cross-linking or a non-cross-linking polyisobutylene.

In a preferred embodiment of the hollow profile spacer, it includes a main body, wherein a gas- and vapor-tight barrier is applied at least on the outer surface of the spacer, preferably on the outer surface and on a portion of the pane contact surfaces. The gas- and vapor-tight barrier improves the leak-tightness of the spacer against gas loss and moisture penetration. Preferably, the barrier is applied on approximately one-half to two-thirds of the pane contact surfaces.

In a preferred embodiment, the gas- and vapor-tight barrier is implemented as a film. This barrier film includes at least one polymeric layer as well as one metallic layer or one ceramic layer. The layer thickness of the polymeric layer is between 5 μm and 80 μm, whereas metallic layers and/or ceramic layers with a thickness of 10 nm to 200 nm are used. Within the layer thicknesses mentioned, particularly good leak-tightness of the barrier film is achieved. The barrier film can be applied, for example, adhesively bonded, on the polymeric main body. Alternatively, the film can be coextruded together with the main body.

Particularly preferably, the barrier film includes at least two metallic layers and/or ceramic layers that are arranged alternatingly with at least one polymeric layer. The layer thicknesses of the individual layers are preferably as described in the preceding paragraph. Preferably, the outward positioned layers are formed by the polymeric layer.

In this arrangement, the metallic layers are particularly well protected against damage. The alternating layers of the barrier film can be bonded or applied on one another in a variety of known prior art methods. Methods for depositing metallic or ceramic layers are well known to the person skilled in the art. The use of a barrier film with an alternating layer sequence is particularly advantageous in terms of the leak-tightness of the system. A defect in one of the layers does not result in a loss of function of the barrier film. By comparison, in the case of a single layer, one small defect can already result in a complete failure. Furthermore, the application of multiple thin layers is advantageous compared to a thick layer since with increasing layer thicknesses, the risk of internal adhesion problems increases. Also, thicker layers have higher conductivity, making such a film less suitable thermodynamically.

The polymeric layer of the film preferably includes polyethylene terephthalate, ethylene vinyl alcohol, polyvinylidene chloride, polyamides, polyethylene, polypropylene, silicones, acrylonitriles, polyacrylates, polymethyl acrylates, and/or copolymers or mixtures thereof. The metallic layer preferably includes iron, aluminum, silver, copper, gold, chromium, and/or alloys or oxides thereof. The ceramic layer of the film preferably includes silicon oxides and/or silicon nitrides.

In an alternative preferred embodiment, the gas- and vapor-tight barrier is preferably implemented as a coating. The coating includes aluminum, aluminum oxides, and/or silicon oxides and is preferably applied by a PVD method (physical vapor deposition). By this means, the production method can be significantly simplified since the polymeric main body is provided, for example, by extrusion, with the barrier coating directly after production and no separate step is necessary for the application of a film. The coating with the materials mentioned delivers particularly good results in terms of leak-tightness and, in addition, presents excellent adhesion properties relative to the outer seal materials used in insulating glazing units.

In a particularly preferred embodiment, the gas- and vapor-tight barrier has at least one metallic layer or ceramic layer that is implemented as a coating and contains aluminum, aluminum oxides, and/or silicon oxides and is preferably applied by a PVD method (physical vapor deposition).

The polymeric main body preferably includes polyethylene (PE), polycarbonates (PC), polypropylene (PP), polystyrene, polybutadiene, polynitriles, polyesters, polyurethanes, polymethyl methacrylates, polyacrylates, polyamides, polyethylene terephthalate (PET), polybutylene terephthalate (PBT), preferably acrylonitrile butadiene styrene (ABS), acrylonitrile styrene acrylester (ASA), acrylonitrile butadiene styrene/polycarbonate (ABS/PC), styrene acrylonitrile (SAN), PET/PC, PBT/PC, and/or copolymers or mixtures thereof. Particularly good results are obtained with these materials.

Preferably, the polymeric main body is glass fiber reinforced. The coefficient of thermal expansion of the main body can be varied and adapted by the selection of the glass fiber content in the main body. By adaptation of the coefficient of thermal expansion of the polymeric main body and of the barrier film or barrier coating, temperature-related stresses between the different materials and flaking of the barrier film or barrier coating can be avoided. The main body preferably has a glass fiber content of 20% to 50%, particularly preferably of 30% to 40%. At the same time, the glass fiber content in the polymeric main body improves strength and stability.

In another preferred embodiment, the polymeric main body is filled with hollow glass spheres or glass bubbles. These hollow glass spheres have a diameter of 10 μm to 20 μm and improve the stability of the polymeric hollow profile. Suitable glass spheres are commercially available under the tradename “3M™ Glass Bubbles”. Particularly preferably, the polymeric main body contains polymers, glass fibers, and glass spheres. An admixture of glass spheres results in an improvement of the thermal properties of the hollow profile.

In an alternative preferred embodiment, the main body is made of wood or wood/polymer mixtures. Wood has low thermal conductivity and is, as a renewable resource, particularly ecologically compatible.

The insulating glazing unit is filled with a protective gas, preferably with a noble gas, preferably, argon or krypton, which reduce the heat transfer value in the insulating glazing unit interspace.

At the corners of the insulating glazing unit, the spacers are preferably linked to one another via corner connectors. Such corner connectors can be implemented, for example, as a molded plastic part with a seal, in which two spacers provided with a miter cut abut. In principle, a variety of geometries of the insulating glazing unit are possible, for example, rectangular, trapezoidal, and rounded shapes. To produce round geometries, the spacer according to the invention can be bent, for example, in the heated state.

In a preferred embodiment, the insulating glazing unit includes, in addition to the first pane and second pane, at least a third pane and is at least a triple glazing unit. The structure of the third pane corresponds to the structure described for the first pane and the second pane. The third pane is, for example, mounted on the first pane or the second pane via another spacer. Alternatively, a double spacer can also be used for triple glazing units in which the third pane is, for example, inserted into a groove between the first pane and the second pane. Such spacers are, among others, known from WO 2014/198431 A1.

The invention further includes a method for producing an insulating glazing unit according to the invention, wherein at least
a) the first pane is bonded to the first pane contact surface of the spacer via a sealant, and
   the second pane is bonded to the second pane contact surface of the spacer via a sealant,
b) the pane arrangement consisting of the panes and the spacer is pressed together,
   wherein the spacer is a hollow profile spacer and, prior to step a), a pyrotechnic module is introduced into at least one hollow chamber of the spacer or, in step a), a pyrotechnic module is arranged in the inner interpane space between the first pane and the second pane. If the pyrotechnic module is introduced into the interpane space, the spacer can be molded as desired, i.e., can be, for example, a hollow profile spacer or a spacer without a hollow chamber.

If the first and/or second pane is a composite pane comprising a plurality of individual planes, these are laminated to form a composite pane prior to step a).

If the spacer used is a hollow profile spacer, the spacer is preferably preshaped into a rectangle prior to step a). Here, the individual spacer profiles can, for example, be provided with a miter cut and linked at the corners by corner connectors. Instead of this, the spacers can also be directly welded to one another, for example, by ultrasonic welding. This preassembled component can be processed on a conventional dual glazing system known to the person skilled in the art.

If an injection moldable thermoplastic spacer is used, this spacer comprising a main body containing a sealant and a desiccant is extruded into the intermediate space between a first pane and a second pane.

The adhesive bonding of the panes onto the pane contact surfaces per step a) can be carried out in any order. Optionally, the adhesive bonding of both panes onto the pane contact surfaces can also be done simultaneously.

Preferably, the inner interpane space between a first pane and a third pane is filled with a protective gas before the pressing of the pane arrangement.

Preferably, following step b), the outer interpane space is at least partially, preferably completely, filled with an external seal. A plastic sealing compound, for example, is used as outer insulation.

The invention further includes the use of the insulating glazing unit according to the invention as a bullet-resistant glazing, preferably in building interiors, in building exteriors, and/or in façades.

In the following, the invention is explained in detail with reference to drawings. The drawings are purely schematic representations and not true to scale. They in no way restrict the invention. They depict:

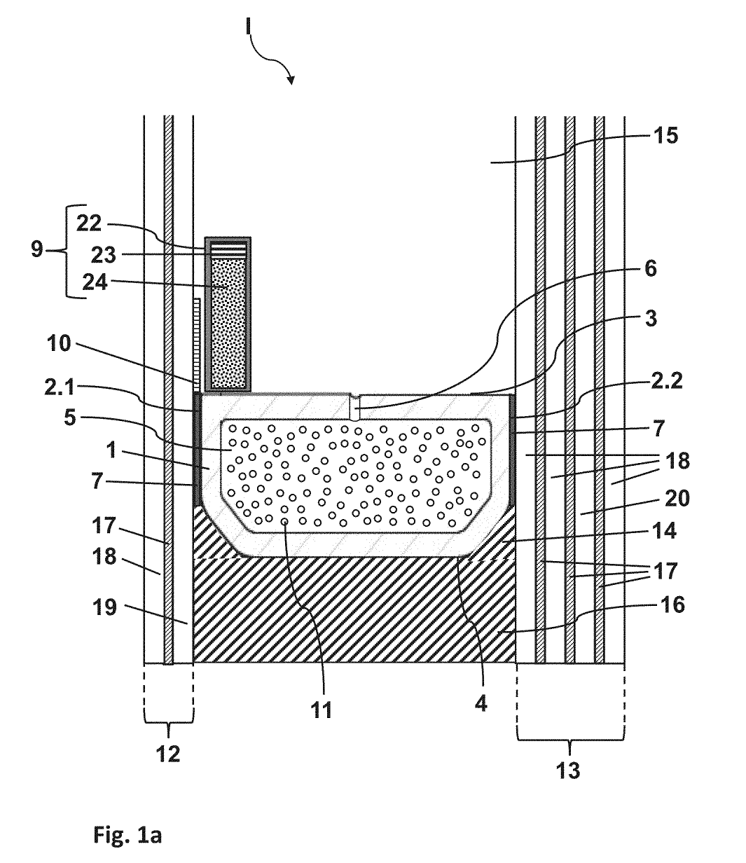

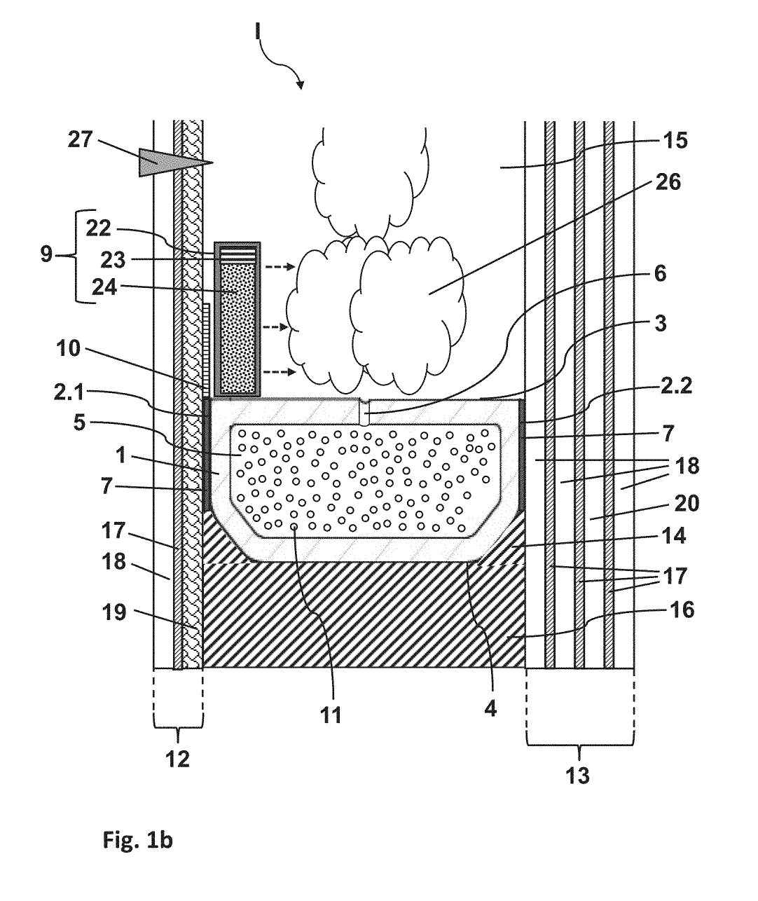

FIG. 1a, 1b a cross-section of an embodiment of the insulating glazing unit according to the invention having a hollow profile spacer, a glass breakage detector, and a pyrotechnic module in the inner interpane space, before and after activation of the pyrotechnic module, respectively,

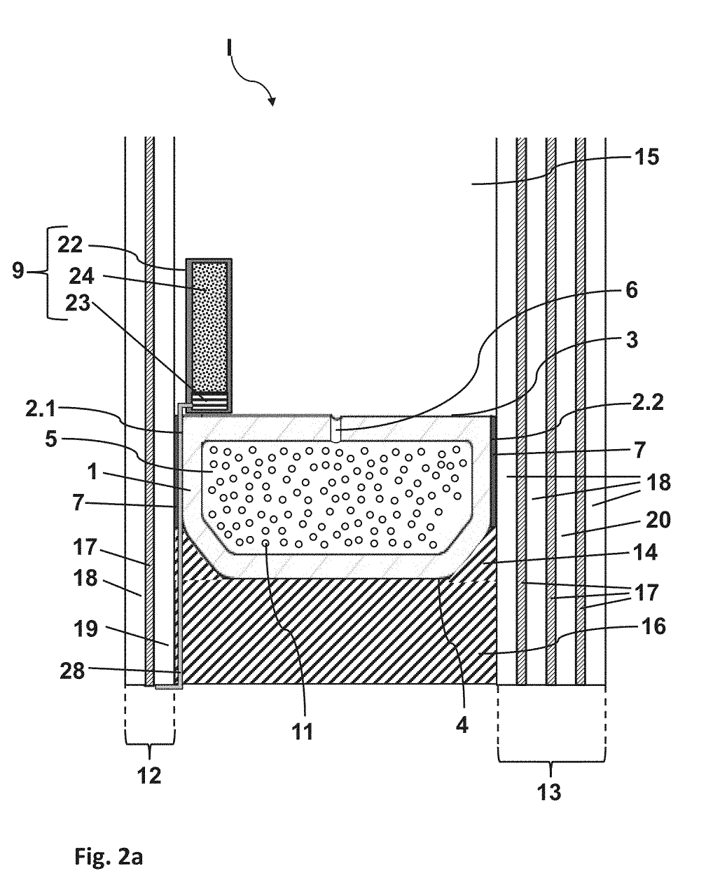

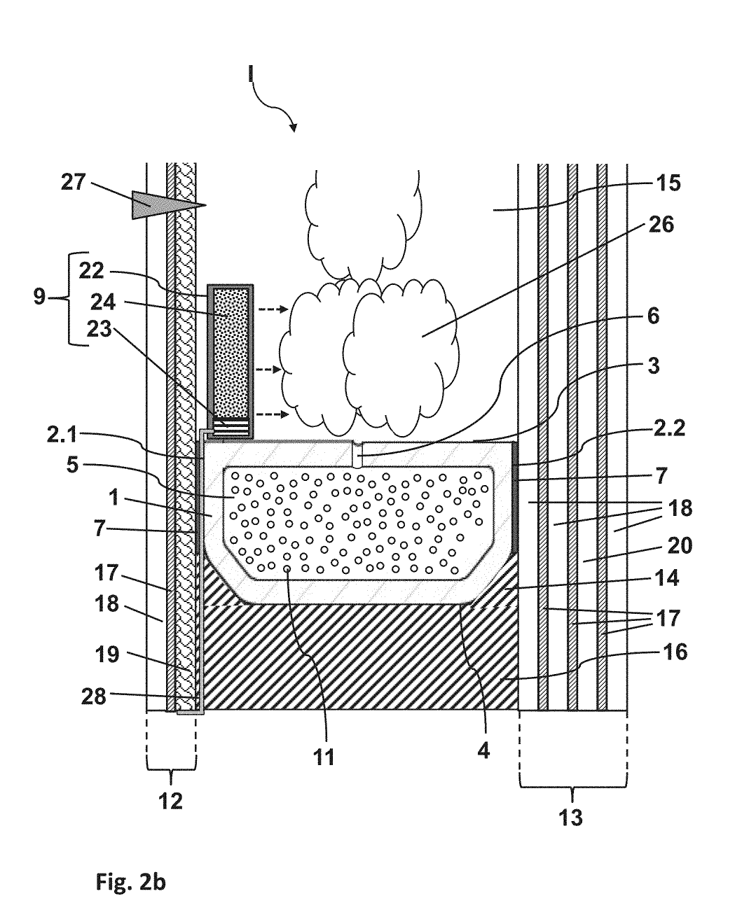

FIG. 2a, 2b a cross-section of another embodiment of the insulating glazing unit according to the invention having a hollow profile spacer and a pyrotechnic module in the inner interpane space, which is activated by a rip cord, before and after activation of the pyrotechnic module, respectively,

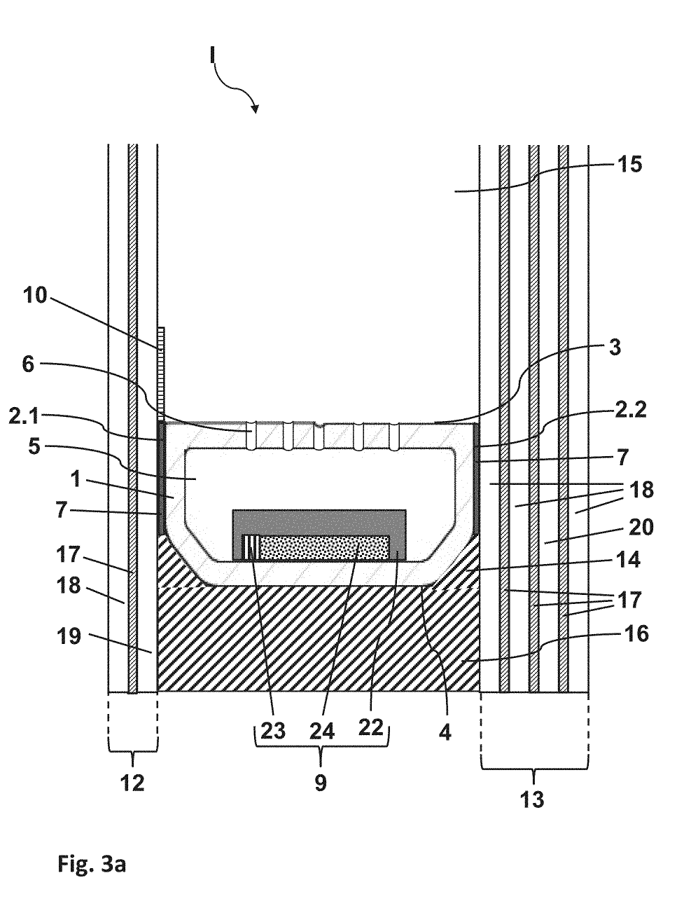

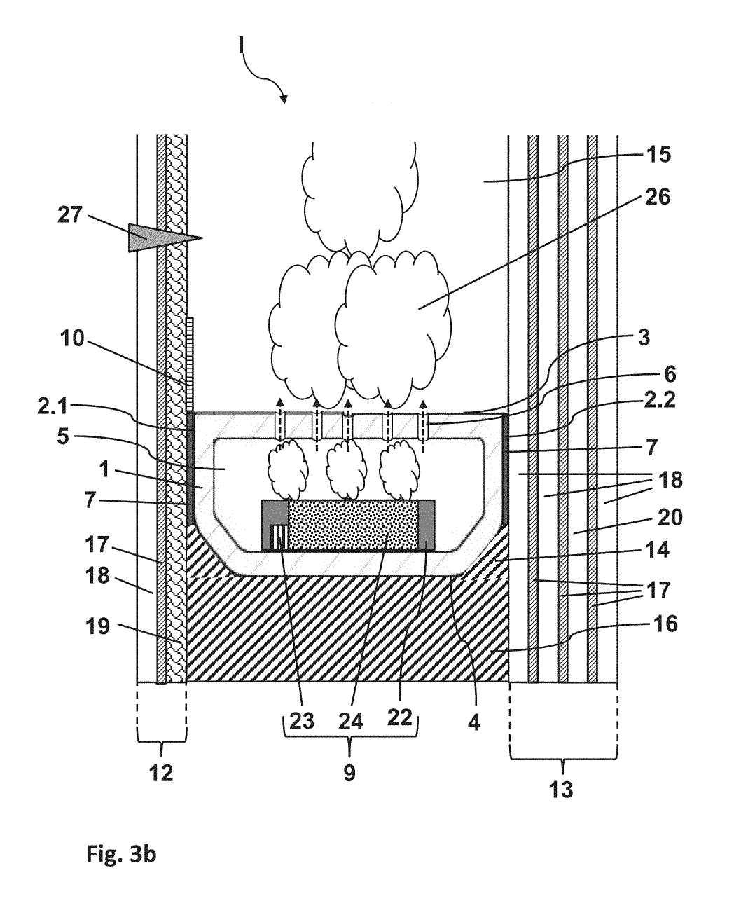

FIG. 3a, 3b a cross-section of another possible embodiment of the insulating glazing unit according to the invention having a hollow profile spacer, a glass breakage detector, and a pyrotechnic module in the hollow chamber of the spacer, before and after activation of the pyrotechnic module, respectively,

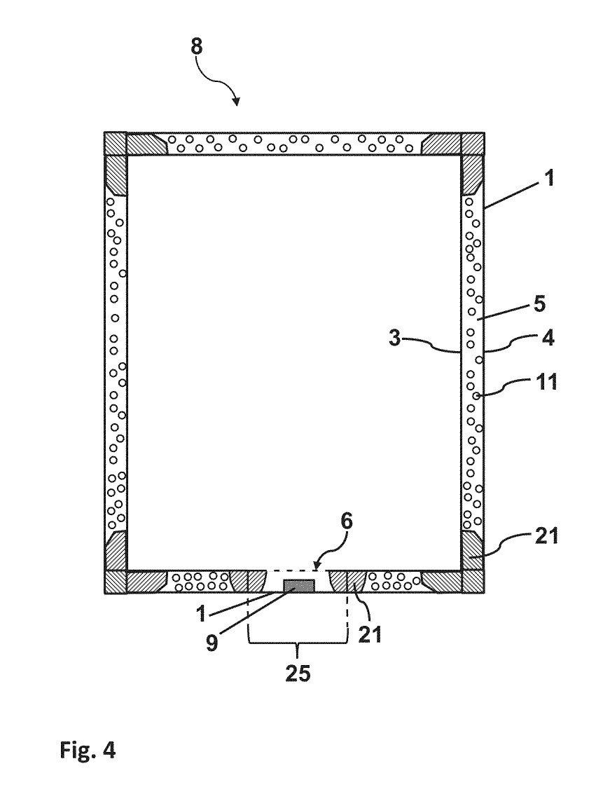

FIG. 4 a preassembled spacer frame having a spacer module with an integrated pyrotechnic module,

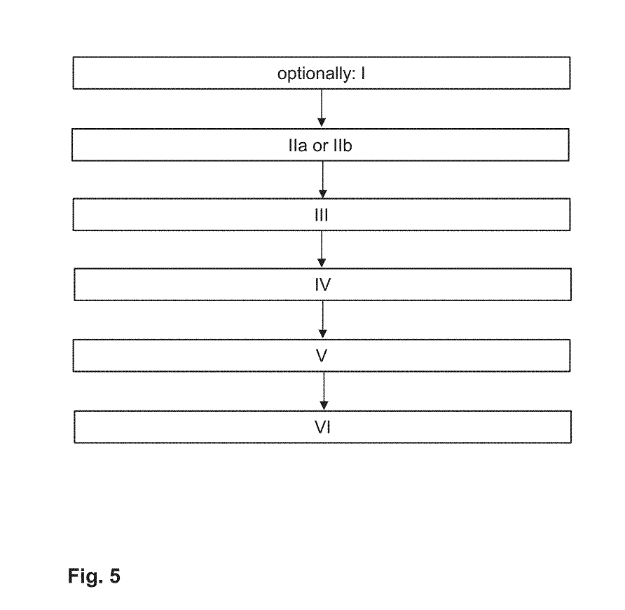

FIG. 5 a flowchart of a possible embodiment of the method according to the invention.

FIGS. 1a and 1b depict a cross-section through an insulating glazing unit I having a hollow profile spacer 1, a glass breakage detector 10, and a pyrotechnic module 9 in the inner interpane space 15, before (cf. FIG. 1a) and after (cf. FIG. 1b) activation of the pyrotechnic module, respectively. The spacer 1 comprises a main body having a first pane contact surface 2.1, a second pane contact surface 2.2 running parallel thereto, a glazing interior surface 3, and an outer surface 4. The outer surface 4 runs perpendicular to the pane contact surfaces 2.1, 2.2 and connects the pane contact surfaces 2.1 and 2.2. The sections of the outer surface 4 adjacent the pane contact surfaces 2.1 and 2.2 are inclined at an angle of approx. 45° relative to the outer surface 4 in the direction of the pane contact surfaces 2.1 and 2.2. A hollow chamber 5 is situated between the outer surface 4 and the glazing interior surface 3. The first pane 12 of the insulating glazing unit I is bonded via a sealant 7 to the first pane contact surface 2.1 of the spacer 1, whereas the second pane 13 is bonded via a sealant 7 to the second pane contact surface 2.2. The space between the first pane 12 and the second pane 13, delimited by the glazing interior surface 3, is defined as the inner interpane space 15. The inner interpane space 15 is connected to the hollow chamber 5 lying thereunder via the openings 6 in the glazing interior surface. A desiccant 11 that draws the moisture out of the inner interpane space 15 is situated in the hollow chamber 5. The outer interpane space 16, which is delimited by the outer surface 4 and the first pane 12 and the second pane 13, is completely filled with the outer seal 14. The first pane 12, which forms the attack side of the glazing, is made of a composite pane comprising a glass pane 18 made of soda lime glass and a pane of a single-pane safety glass 19. The second pane 13, which is positioned on the protected side of the glazing, is made of a composite pane comprising three glass panes 18 made of soda lime glass as well as one thermoplastic polymeric pane 20 made of polycarbonate. The individual panes of the first pane 12 and of the second pane 13 are bonded to one another in each case via laminating films 17. The pyrotechnic module 9 comprises a casing 22 that contains an igniter 23 and a pyrotechnic composition 24. The pyrotechnic composition 24 consists of potassium chlorate and ammonium chloride. The glass breakage detector 10 is mounted on the inner side of the single-pane safety glass 19 facing the inner interpane space 15. The glass breakage detector 10 and the pyrotechnic module 9 are mounted in the immediate vicinity of each other such that they can be contacted in a simple manner via an electric conductor (not shown). Alternatively, the pyrotechnic module can also be mounted adjacent the second pane 13 or at any other point of the insulating glazing unit so long as an aerosol-permeable connection to the inner interpane space exists. An arrangement of the components in the immediate vicinity has the advantage that there is only a short transmission path. An arrangement of the components that yields a longer transmission path can also be reasonable in terms of visual concealment of the pyrotechnic module 9 or in terms of better protection of the module against gunfire. Particularly in the case of longer transmission paths, wireless signal transmission is preferable instead of the electrical conductor. The glass breakage detector 10 is an electric conductor loop (alarm net). When a projectile 27 reaches the first pane 12 of FIG. 1b, the single-pane safety glass 19 splinters with the pattern characteristic for this type of glass. This interrupts the electric conductor loop used as a glass breakage detector 10 and triggers the ignition of the pyrotechnic composition 24 via the igniter 23 of the pyrotechnic module 9. As a result, an aerosol 26, smoke in the present case, develops in the inner interpane space 15. This aerosol 26 obstructs the view through the insulating glazing unit I in accordance with the invention.

FIGS. 2a and 2b depict a cross-section of another embodiment of the insulating glazing unit according to the invention having a hollow profile spacer and a pyrotechnic module in the inner interpane space that is activated by a rip cord, before (cf. FIG. 2a) and after (cf. FIG. 2b) activation of the pyrotechnic module, respectively. The basic structure corresponds to that described in FIGS. 1a and 1b. In contrast, the igniter 23 is a rip igniter that is activated via a rip cord 28. The rip cord 28 surrounds a section of the single-pane safety glass 19 of the first pane 12. In this case as well, activation occurs upon breakage of the single-pane safety glass 19.

FIGS. 3a and 3b depict a cross-section of another possible embodiment of the insulating glazing unit I according to the invention having a hollow profile spacer 1, a glass breakage detector 10, and a pyrotechnic module 9 in the hollow chamber 5 of the spacer 1, before (cf. FIG. 3a) and after (cf. FIG. 3b) activation of the pyrotechnic module 9, respectively. The basic structure corresponds to that described in FIGS. 1a and 1b. In contrast, the pyrotechnic module 9 is introduced into the hollow chamber 5 of the spacer 1. The number and size of the openings 6 was increased, compared to the embodiments with a pyrotechnic module in the intermediate space, in order to ensure unobstructed escape of the aerosol 26 from the hollow chamber 5 into the inner interpane space 15. The spacer 1 can have a wire passage (not shown) for an electric conductor (likewise not shown) for connecting a glass breakage detector 10 and a pyrotechnic module 9.

FIG. 4 depicts a preassembled spacer frame 8 having a spacer module 25 with an integrated pyrotechnic module 9. The spacer 1 of the spacer frame 8 corresponds to that described in FIGS. 3a and 3b. In contrast, the pyrotechnic module 9 is not inserted directly into a section of the spacer frame but is integrated as a prefabricated component, as spacer module 25, into the spacer frame 8. The connection of the spacer module 25 to an integrated pyrotechnic module 9 is done via a plug-in connector 21. The corners of the spacer frame 8 are also connected by plug-in connectors 21. The spacer module 25 can be installed at any position along the edges of the spacer frame 8. In the case of very large dimensions of the insulating glazing unit, central placement in the center of one edge of the spacer frame 25 can be advantageous to ensure uniform distribution of the aerosol. To the extent possible from this perspective, the module is, however, preferably positioned adjacent a corner plug-in connector 21 (corner connector). Since each plug-in connection represents a potential defect site of the insulating glazing unit, the number of possible defect sites can thus be reduced. Furthermore, a corner placement is advantageous when an external power supply is provided. A wire necessary for this can be routed through a corner plug-in connector into the outer interpane space in a simple manner.

FIG. 5 depicts a flowchart of a possible embodiment of the method according to the invention for producing an insulating glazing unit comprising the steps:
I optionally: the first pane 12 and the second pane 13 are introduced as a composite pane made up of at least two individual panes with interposition of at least one laminating film 17
IIa the pyrotechnic module 9 is introduced into the hollow chamber 5 of a spacer 1
or
IIb the pyrotechnic module 9 is arranged in the inner interpane space 15 between the first pane 12 and the second pane 13
III the first pane 12 is bonded to the first pane contact surface 2.1 of the spacer 1 via a sealant 7
IV the second pane 13 is bonded to the second pane contact surface 2.2 of the spacer 1 via a sealant 7
V the pane arrangement made up of the panes 12 and 13 and the spacer 1 is pressed together
VI the outer interpane space 18 is completely filled with an outer seal 16.

### LIST OF REFERENCE CHARACTERS

I insulating glazing unit
1 spacer
2 pane contact surfaces
2.1 first pane contact surface
2.2 second pane contact surface
3 glazing interior surface
4 outer surface
5 hollow chamber
6 openings
7 sealant
8 spacer frame
9 pyrotechnic module
10 glass breakage detector
11 desiccant
12 first pane
13 second pane
14 outer seal
15 inner interpane space
16 outer interpane space
17 laminating film
18 glass pane
19 single-pane safety glass
20 thermoplastic polymeric pane
21 plug-in connector
22 casing
23 igniter
24 pyrotechnic composition
25 spacer module with an integrated pyrotechnic module 9
26 aerosol
27 projectile
28 rip cord

1.-15. (canceled)

16. An insulating glazing unit, comprising:
a first pane;
a second pane;
a circumferential spacer comprising a first pane contact surface, a second pane contact surface that is parallel to the first pane contact surface, a glazing interior surface, and an outer surface; and
a pyrotechnic module comprising a pyrotechnic composition and an igniter,
wherein the first pane is bonded to the first pane contact surface, and the second pane is bonded to the second pane contact surface,
wherein the first pane, the second pane, and the glazing interior surface enclose an inner interpane space, and
wherein the pyrotechnic composition is configured to release an aerosol in the inner interpane space after activation by the igniter.

17. The insulating glazing unit according to claim 16, wherein the igniter is electrically conductingly connected to a glass breakage detector configured to ignite the igniter.

18. The insulating glazing unit according to claim 17, wherein:
at least one of the first pane and the second pane comprises a single-pane safety glass, and
the glass breakage detector detects a breakage of the single-pane safety glass.

19. The insulating glazing unit according to claim 18, wherein the glass breakage detector is implemented as an electrically conducting loop on a surface of the single-pane safety glass.

20. The insulating glazing unit according to claim 16, wherein the igniter is a rip igniter that is connected to a rip cord for ignition.

21. The insulating glazing unit according to claim 20, wherein the rip cord at least partially contacts one of the first pane and the second pane along at least one edge section of said pane.

22. The insulating glazing unit according to claim 16, wherein the pyrotechnic module is attached in the inner interpane space.

23. The insulating glazing unit according to claim 16, wherein:
the circumferential spacer has at least one hollow chamber, and
the pyrotechnic module is attached in the at least one hollow chamber.

24. The insulating glazing unit according to claim 23, wherein at least one section of the circumferential spacer is implemented as a spacer module within which the pyrotechnic module is integrated.

25. The insulating glazing unit according to claim 16, wherein the pyrotechnic composition comprises potassium chlorate and ammonium chloride.

26. The insulating glazing unit according to claim 16, wherein at least one of the first pane and the second pane is a composite.

27. The insulating glazing unit according to claim 16, wherein at least one of the first pane and the second pane includes at least one thermoplastic polymeric pane.

28. The insulating glazing unit according to claim 16, wherein the insulating glazing is at least a triple glazing unit that further comprises at least a third pane.

29. A method for producing an insulating glazing unit, comprising:
a) bonding a first pane to a first pane contact surface of a spacer via a sealant;
b) bonding a second pane to a second pane contact surface of the spacer via a sealant, thereby providing a pane arrangement comprising the first and second panes and the spacer; and
c) pressing the pane arrangement together,
wherein prior to step a), a pyrotechnic module is introduced into at least one hollow chamber of the spacer, or
wherein in step a), a pyrotechnic module is arranged in an inner interpane space between the first pane and the second pane.

30. A method, comprising:
providing an insulating glazing unit according to claim 16; and
using the insulating glazing unit as a bullet-resistant glazing.

31. The method according to claim 30, wherein using the insulating glazing unit comprises using the insulating glazing unit in one or more of building interiors, building exteriors, and façades.
